(19) United States
(12) Patent Application Publication
(10) Pub. No.: US 2010/0267001 A1
(43) Pub. Date: Oct. 21, 2010

(54) PORTABLE WRITING BOARD SYSTEM

(75) Inventor: Naohito SUGAI, Sagamihara (JP)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/750,868

(22) Filed: Mar. 31, 2010

Related U.S. Application Data
(60) Provisional application No. 61/165,362, filed on Mar. 31, 2009.

(51) Int. Cl. B43L 1/00

(52) U.S. Cl. 434/408

(57) ABSTRACT

A portable writing system comprising an assembly of panels, at least one of which has a writing surface thereon, connected by joints which may be repeatedly rearranged from an open or use configuration to a closed or transport configuration, providing exceptional convenience and portability.

### PRIORITY CLAIM

This application claims priority to U.S. Provisional Patent Application No. 61/165,362, filed Mar. 31, 2009, which is incorporated herein by reference.

### FIELD OF INVENTION

The present invention relates to writing boards, e.g., dry erase or white boards. Specifically the invention relates to portable writing board systems that can be easily reconfigured between an open or use configuration and a closed or packed configuration, e.g., for storage, movement to a different location, etc.

### BACKGROUND

Dry erase boards, sometimes referred to as white boards, have been used as a writing surface for years because of their convenience and versatility. Easily written in, erased, etc. with a variety of markers, such boards provide a convenient means for expression which eliminates the mess and trouble of a chalk board.

In many instances, the boards are permanent fixtures on the walls of conference rooms, etc. In some instances, the boards are portable to accommodate movement of the boards, e.g., to meetings in other locations, etc., as desired. Illustrative examples of systems intended for mobile use include U.S. Pat. No. 6,155,325 (Shirer) and U.S. Pat. No. 6,666,424 (Richardson).

The need exists for additional, convenient, effective, and potentially low cost portable writing board systems.

### SUMMARY OF INVENTION

The present invention relates to a portable dry erase or white board system. The writing board system is portable, free-standing, and can be repeatedly packed, unpacked, and/or repacked, transported, and utilized readily at meetings, conferences, seminars, classes, and the like. Systems of the invention are well suited for use as table top or desk top displays.

In brief summary, a portable writing system of the invention comprises a first panel, a second panel, and a third panel, each of the panels having first and second major surfaces and wherein the panels are arranged in series such that the second panel is located between the first panel and the third panel. A first joint connects the first panel to the second panel and a second joint connects the third panel to the second panel. At least one of the second panel and the third panel has a writing surface on the second major surface thereof. In accordance with the present invention, the system can be repeatedly arranged from a closed configuration to an open configuration and back as desired.

The members of the system can be repeatedly rearranged from an open or use configuration to a closed or transport configuration, providing exceptional convenience and portability.

### BRIEF DESCRIPTION OF DRAWING

The invention will be explained with reference to the drawing wherein:

FIG. 1 is a plan view of one illustrative embodiment of the invention showing the first major surfaces of each the three panels;

FIG. 2 is an end view of the embodiment of claim 1 shown in packed configuration; and

FIG. 3 is an end view of the embodiment of claim 1 shown in use configuration.

The figures are idealized and not to scale and are intended to be no-limiting.

### DETAILED DESCRIPTION OF ILLUSTRATIVE EMBODIMENTS

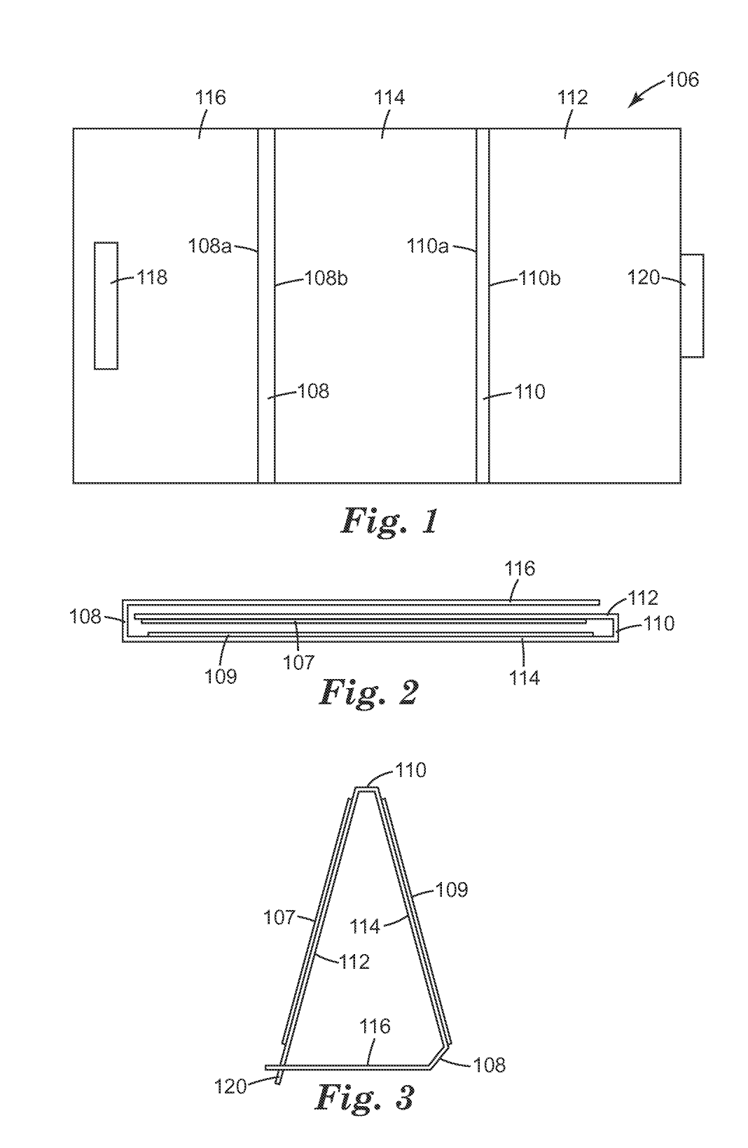

FIG. 1 shows an illustrative embodiment of a portable writing system 106 of the invention. System 106 comprises a first panel 116, a second panel 114, and a third panel 112. Each of the panels has first and second major surfaces, the first major surfaces of each are shown in the Fig. The panels are arranged in series such that the second panel 114 is located between the first panel 116 and the third panel 112. A first joint 108 connects the first panel 116 to the second panel 114 and a second joint 110 connects the third panel 112 to the second panel 114.

FIG. 2 shows an end view of system 106 with the members arranged in a closed configuration by repositioning the three panels relative to one another, e.g., by bending or moving via the first and second joints. When system 106 is in packed configuration, the display surfaces 107, 109 on third panel 112 and second panel 114, respectively, are protected within the assembly. In this configuration, the system is conveniently moved, taken on a train, carried, packed in luggage, etc. In this embodiment, second panel 114 has writing surface 109 on the second major surface thereof and third panel 112 has writing surface 107 on the second major surface thereof. In the packed configuration, writing surface 107 and 109 are arranged in facing juxtaposition to one another and enclosed so as to be protected, while the first major surface of second panel 114, first major surface of first panel 116, and perhaps (depending upon the relative sizes of the panels) a portion of the first major surface of third panel 112 are exposed. To place the assembly in packed configuration, typically first the second major surface of third panel 112 is folded toward the second major surface of second panel 114 (with panels moving relative to one another via joint 110). The respective second major surfaces of panels 114 and 112, at least one of which has a writing surface thereon, may contact one another or remain spaced apart, such as by action of stops or spacers (not shown) and/or action of joint 110. Thereafter, the second major surface of first panel 116 is folded toward the first major surface of third panel 112. The second major surfaces of panels 116 and first major surface of third panel 112 may contact one another or remain spaced apart, such as by action of stops or spacers (not shown) and/or action of joint 108.

When it is to be used, the system is opened from the packed configuration shown in FIG. 2 to the use configuration shown in FIG. 3 by bending at joints 108 and 110 such that writing surfaces 107 and 109 are presented to be visible and used. This is achieved by folding first panel 116 away from third panel 112 (via joint 108) and third panel 112 away from second panel 114 (via joint 110) and continuing until the second major surfaces of second panel 114 and third panel 112 are presented. Typically, it is preferred that the assembly may be fixed into use configuration, e.g., by fastening optional tab 120 through slot 118 as discussed below.

The first joint 108 connecting first panel 116 and second panel 114 and second joint connecting second panel 114 and first panel 112 may each be a single (or alternatively two or more) fold line in the panel permitting portions thereof to be arranged as described herein. In the embodiment shown, joint 108 is made up of two parallel fold lines, i.e., fold lines 108a and 108b, and joint 110 is also made up of two parallel fold lines, i.e., fold lines 110a and 110b. In the embodiment show, fold lines 108a and 108b are spaced somewhat farther apart than are fold lines 110a and 110b such that when the assembly is arranged in packed configuration it will lie flat, i.e., joint 108 is wide enough to accommodate joint 110 and first panel 116 folded between second panel 114 and third panel 112. In other embodiments, the respective panels may be separate members connected by such joints as living hinges, mechanical hinges, durable tapes (e.g., cloth binding tapes), rings, spiral binding, etc. Those skilled in the art will be able to readily select suitable joints to connect the panels used.

Visible in FIG. 1 is optional opening 118 near the distal edge of first panel 116 (“distal” meaning the edge farther from second panel 114) and optional tab 120 extending from the distal edge of first panel 112 (“distal” meaning the edge farther from second panel 114). The system is arranged in the use configuration, as the first, second, and third panels are arranged relative to one another, tab 120 can be inserted through slot 118 to fasten them together and hold the system in the use configuration as desired. When in the use configuration, tab 120 may extend through third panel 116 to contact the surface (not shown) on which the system is placed.

It will typically be preferred to incorporate one or more fasteners in the system, e.g., to secure it in use configuration and/or to secure it in packed configuration. Those skilled in the art will be able to readily select suitable fasteners, illustrative examples include one or more tabs and corresponding slots, buckles, hooks, clasps, snaps, screws, etc.

In the embodiment shown in FIG. 10, segment 116 has opening 118 formed therein into which tab 120 will be inserted to secure the article in use configuration.

The panels may be flexible or rigid and are preferably self-supporting and dimensionally stable. Those skilled in the art will be able to readily select suitable materials for the various components of the invention. Illustrative examples of materials that may be used for the panels corrugated cardboard, past board, foam board, self-supporting polymeric, wood, or metal sheets, etc., and combinations thereof. The panels may be essentially monolayer construction or may comprise multiple layers. The materials selected are preferably sufficiently durable and strong for the desired application as well as being light to make transport more convenient. Each of the three panels may be made of the same materials or different materials may be selected for each as desired.

At least one of the second panel and the third panel, and typically each panel, has a writing surface on the second major surface thereof. In accordance with the present invention, the system can be repeatedly arranged in a closed configuration and an open configuration.

The writing surface is dry erasable, i.e., it is capable of being used as a dry erasable writing surface. The surface of the respective panel may be inherently dry erasable or the panel may have a layer or coating thereon to impart desired dry erasable properties thereto.

Suitable materials can be readily selected by those skilled in the art.

Acceptance of ink on the writing surface as written indicia without beading of the ink can be defined as the “wettability” of the dry erase writing surface. Wettability refers to a writing line that can retain its shape as the solvent dries. Dewetting of the solvent causes the line to move in or break at certain points, causing voids in the writing. Acceptable wettability (or writing without dewetting) is accomplished if the surface energy of the writing surface is greater than the surface tension of the solvents in the marker inks. The writing surface additionally provides a level of “erasability” which allows the user to wipe away (e.g. with a dry cloth or dry eraser) indicia written with a dry erase marker once it is no longer desired. Acceptable erasability is achieved if the surface energy of the writing surface is sufficiently low to prevent tenacious adhesion of the binders and other solids in the marker inks to the writing surface. Solvent compositions of dry erase markers are typically listed on the marker or reported on the MSDS for the marker. Common solvents for dry erase markers include, for example, ethanol, isopropanol, methyl isobutyl ketone and n-butyl acetate. One solvent with a high surface tension is n-butyl acetate, having a surface tension of about 25 mJ/m². Therefore, in some embodiments, a dry ease surface can be wettable by solvents with a surface tension of about 25 mJ/m² or less. In one embodiment, the surface energy of the writing surface is within the range of about 25 mJ/m² to about 40 mJ/m². In another embodiment, the surface energy of the writing surface is within the range of about 30 mJ/m² to about 35 mJ/m², as measured by the Dyne Pen Test. In the current inventive dry erase article, writing surface is easily erasable with a simple felt eraser.

It is typically desirable for the writing surface to have a surface energy of greater than or equal to about 25 mJ/m². This surface energy of writing surface prevents ink from typical dry erase and permanent markers from beading up on the writing surface. Written indicia is received as a continuous layer, preventing beading up or “gaps” in the lines forming written indicia. Typical marker solvents include ethanol, isopropanol, methyl isobutyl ketone, n-butyl acetate, ethyl acetate, n-propanol, and n-butanol. In order for the marker to completely wet out the dry erase surface without beading up, the surface energy of the dry erase surface must be greater than the surface tension of the solvents in the maker. The solvent in the list above with the highest surface tension is n-butyl acetate, with a surface tension of about 25 mJ/m². Therefore, in one embodiment, the writing surface of the dry erase article has a surface energy greater than or equal to about 25 mJ/m². In an alternate embodiment, the writing surface of the dry erase article has a surface energy greater than or equal to about 30 mJ/m² as measured by the Dyne Pen Test. Additionally, written indicia can preferably be quickly removed from dry erase article with a minimum of wiping and a minimum of absorbance of ink (or “ghosting”) by dry erase article. Acceptable removability of the ink is achieved if the surface energy of the writing surface is sufficiently low to prevent the binders and other solids in the marker inks from adhering tenaciously to the writing surface. Therefore, in one embodiment, the writing surface of the dry erase article has a surface energy less than or equal to about 40 mJ/m². In an alternate embodiment, the writing surface of the dry erase article has a surface energy less than or equal to about 35 mJ/m².

Illustrative examples of suitable materials for use in the writing surface are sheets and films of transparent polymeric resins, including both thermoplastic and thermoset resins that are coated with a radiation curable hardcoat. Example polymeric resins suitable for use include polyesters, polyethers, polyamides, polyurethanes, polyacrylates, polyethylene, polypropylene, polyvinyls, cellulose esters, epoxy resins, phenolic resins, and the like.

The front surface of the writing surface may be substantially smooth or slightly roughened as desired. As is known to those skilled in the art of dry erasable surfaces, slight texturing or roughening of the surface, e.g., such as be embossing or other suitable means, may be used to achieve reductions in glare and optimize writability and erasability performance. For example, in some embodiments, the front surface of the writing member of articles of the invention will have an average surface roughness Ra ranging from about 60 to about 1000, as measured by a contacting stylus profilometer.

In addition to films with UV curable hardcoats, it is possible to directly coat a UV curable coating formulation on the projection member. Exemplary UV curable formulations comprise multi functional acrylate monomers, multifunctional urethane acrylate monomers, monofunctional acrylate monomers and a UV initiator. In addition to these materials, the UV curable formulation may contain particles or flatting agents. The surface energy of the cured formulation may be reduced by the addition of fluorine or silicone containing monomers.

Among the advantages of a system of the invention is that the members of the system can be repeatedly rearranged from an open or use configuration to a closed or transport configuration, providing exceptional convenience and portability. As used herein, “use configuration” refers to the configuration in which the display system is used to display information, e.g., the white board is presented to be written on and viewed by participants in a meeting. As used herein, “packed configuration” refers to the configuration in which the system has been closed and packed for transport, e.g., from one location to another, for storage, travel, etc. It will be understood that the system may be moved while in the use configuration albeit possibly less conveniently.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. A portable writing system comprising a first panel, a second panel, and a third panel each of said panels having first and second major surfaces and wherein said panels are arranged in series such that said second panel is located between said first panel and said third panel, wherein a first joint connects said first panel to said second panel and a second joint connects said third panel to said second panel, wherein at least one of said second panel and said third panel has a writing surface on said second major surface thereof.

2. The system of claim 1 wherein said second panel has a dry erasable writing surface thereon.

3. The system of claim 1 wherein said third panel has a dry erasable writing surface thereon.

4. The system of claim 1 wherein said first panel has an opening near the distal edge thereof and said third panel comprises a tab extending from the distal edge thereof.
